(19) United States
(12) Patent Application Publication
(10) Pub. No.: US 2023/0400361 A1
(43) Pub. Date: Dec. 14, 2023

(54) SYSTEMS AND METHODS FOR CELL TEMPERATURE MEASUREMENT

(71) Applicant: Meta Platforms Technologies, LLC, Menlo Park, CA (US)

(72) Inventors: Rajat Mittal, Fremont, CA (US); Ethan Chen, Mountain View, CA (US); Samvit Monga, Los Gatos, CA (US); Mark Shintaro Ando, Seattle, WA (US); Adam Alan Mudrick, San Carlos, CA (US); Jason Howard, Alpharetta, GA (US)

(73) Assignee: Meta Platforms Technologies, LLC, Menlo Park, CA (US)

(21) Appl. No.: 17/528,151

(22) Filed: Nov. 16, 2021

Related U.S. Application Data
(60) Provisional application No. 63/114,501, filed on Nov. 16, 2020.

(51) Int. Cl. G01K 7/24; H01M 10/48; H01M 10/42

(52) U.S. Cl. CPC G01K 7/24; H01M 10/486; H01M 10/425; H01M 10/482; H01M 2010/4271

(57) ABSTRACT

Provided is a method of estimating temperature in a device including a main printed circuit board (PCB), a protection and control module (PCM), and one or more batteries electrically connected to the PCM. The method includes sensing a temperature of the PCB, via a PCB temperature sensor and sensing a temperature of the PCM via a PCM temperature sensor. The method also includes estimating a temperature of at least one of the batteries based on (i) the temperature determined via the PCB temperature sensor and (ii) the temperature determined via the PCM temperature sensor.

### I. CROSS-REFERENCE TO RELATED APPLICATIONS

The present application claims benefit to U.S. Provisional Patent Application No. 63/114,501, filed on Nov. 16, 2020, the disclosure of which is incorporated herein in its entirety by reference.

### II. TECHNICAL FIELD

The present disclosure relates to battery cells and to battery packs including a plurality of cells. More particularly, the present disclosure relates to cell temperature measurement and battery management.

### III. Background

Accurate measurement of Li-ion battery temperature in a device such as a virtual reality (VR) headset is required to perform various battery management functions, including but not limited to charging, gauging, balancing and protection. Typically, the cell temperature is measured using thermistors that are soldered on to the protection control module (PCM) and housed in the terrace area of the PCM. Tabs of the battery cells may be soldered on the PCM.

During normal operation, measurement of the battery temperature could be affected by localized heating of the PCM when supplying large charge or discharge currents. Overprediction of temperature could lead to premature throttling and/or shutdown of the device leading to degraded performance and user experience. To address this issue some of the existing solutions are as follows.

A typical method is to correct for the offset between the actual and reported temperatures. However, since the offset varies with the device and with each use case, a single offset or offset correction cannot address the issue completely. Choosing a conservative offset could leave performance on the table by impeding the use of the device in a state where it is perfectly safe to operate. Conversely, an aggressive offset could potentially go outside of cell specifications.

Yet another typical approach is to measure instantaneous power and apply correction factors when the power levels exceed certain thresholds. Such methods could have issues and lead to inaccurate measurements because as the instantaneous power is constantly varying. Generally, typical approaches of estimating battery temperature are limited to using measurements from a temperature sensor disposed on the PCM.

### IV. Summary

The embodiments featured herein help solve or mitigate the above-mentioned issues as well as additional shortcomings relating to battery cell temperature measurement and management known in the art. For example, several embodiments disclosed herein feature software, hardware, and/or combinations thereof that are configured to accurately measure battery temperature and PCM temperature based on a plurality of thermistors including at least one thermistor disposed or associated with the PCM and at least one other thermistor disposed or associated with another component of the device. Such other component may be, by example and without limitation, a main printed circuit board (PCB) of the device. Generally, such other component may be a substrate configured to have electronic components mounted thereon.

Under certain circumstances, an embodiment of the invention includes a method of estimating temperature in a device including a main printed circuit board (PCB), a protection and control module (PCM), and one or more batteries electrically connected to the PCB and the PCM. The method includes sensing a temperature of the PCB, via a PCB temperature sensor and sensing a temperature of the PCM via a PCM temperature sensor. The method also includes sensing a temperature of at least one of the batteries as a function of (i) a temperature determined via a battery temperature sensor, (ii) the sensed PCB temperature, and (iii) the sensed PCM temperature.

Further features and advantages of the disclosure, as well as the structure and operation of various embodiments, are described in detail below with reference to the accompanying drawings. It is noted that the disclosure is not limited to the specific embodiments described herein. Such embodiments are presented herein for illustrative purposes only. Additional embodiments will be apparent to persons skilled in the relevant art(s) based on the teachings contained herein.

### V. BRIEF DESCRIPTION OF THE DRAWINGS

Together with the following detailed descriptions, the accompanying drawings illustrate a number of exemplary embodiments in addition to describing and demonstrating various aspects and/or principles set forth in the present disclosure. The accompanying drawings and the brief descriptions are provided to enable one of ordinary skill in the art to practice the various aspects and/or principles set forth the present disclosure.

FIG. 1 illustrates a battery pack assembly including a PCM and a main PCB, which may be an exemplary configuration in a device such as a VR headset.

FIG. 2 illustrates a substrate having a plurality of electronic components mounted thereon and a plurality of thermistors disposed on thereon.

FIG. 3 illustrates a method of estimating the battery temperature using a plurality of thermistors including at least one thermistor disposed or associated with the PCM and at least one other thermistor disposed or associated with the PCB.

FIG. 4 illustrates the performance of the exemplary method relative to the typical measurement scheme of the state-of-the-art (PCM only) and with the actual and true temperature of the battery as measured by a thermocouple.

FIG. 5 illustrates an exemplary system configured to execute one or more aspects of the exemplary methods presented herein.

### VI. DETAILED DESCRIPTION

Embodiments will be described below in more detail with reference to the accompanying drawings. The following detailed descriptions are provided to assist the reader in gaining a comprehensive understanding of the methods, apparatuses, and/or systems described herein as well as modifications thereof. Accordingly, various modifications and equivalents of the methods, apparatuses, and/or systems described herein will be apparent to those of ordinary skill in the art. Descriptions of well-known functions and constructions may be omitted for increased clarity and conciseness.

General embodiments consistent with the teachings set forth herein may include a method and system for measuring the temperature and/or managing a battery pack. By way of example, the method may be embodied as software/firmware instructions programmed into application-specific hardware such as the controller that can interface with the PCM and another component such as a main PCB of device. The device may be, without limitation, a VR headset.

Embodiments will be described below in more detail with reference to the accompanying drawings. The following detailed descriptions are provided to assist the reader in gaining a comprehensive understanding of the methods, apparatuses, and/or systems described herein as well as modifications thereof. Accordingly, various modifications and equivalents of the methods, apparatuses, and/or systems described herein will be apparent to those of ordinary skill in the art. Descriptions of well-known functions and constructions may be omitted for increased clarity and conciseness.

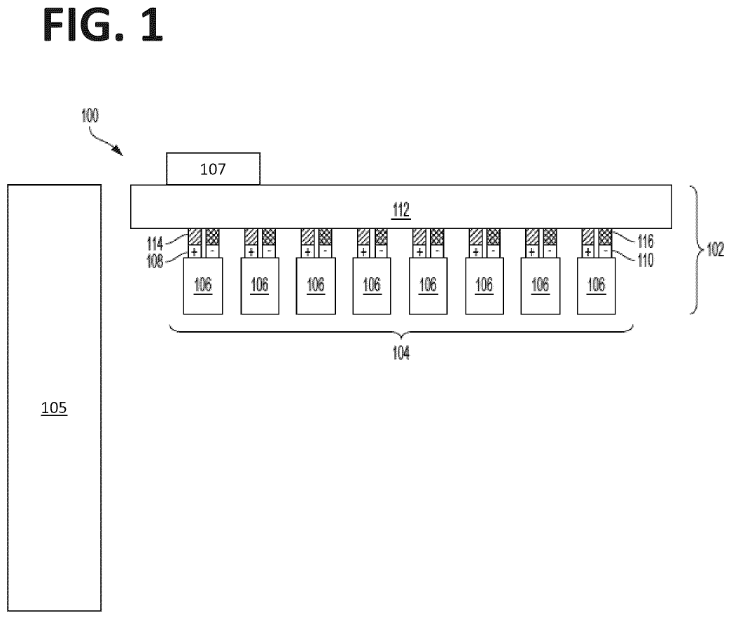

FIG. 1 illustrates an exemplary configuration 100 that may be found in a device such as a VR headset. The configuration 100 includes a protection and control module (PCM) 102 and a main substrate 105 having electronic components mounted thereon. In one embodiment, the main substrate 105 may be a printed circuit board (PCB). In another embodiment, the main substrate 105 may be a flexible material on which electronic components and interconnecting traces may be mounted. The PCM 102 is assembled with a battery pack 104 formed by a plurality of battery cells 106 whose tabs (108 and 110) are welded respectively on the areas 114 and 116 of another substrate, which may be, by example and not by limitation, a printed circuit board 112.

The PCM 102 may further include a controller 107 that is configured to execute the methods described above. While the controller 107 is shown as being collocated with the PCM 102 and specifically, with the PCB 112, other implementation consistent with the teachings presented herein can have the controller 107 located elsewhere while it remains communicatively coupled to the PCM 102 and to the main substrate 105.

The controller 107 may be configured to receive temperature measurements from a plurality of temperatures sensors distributed between the main substrate 105 and the PCM 102. One or more temperature sensors on the PCM 102 may be thermistors.

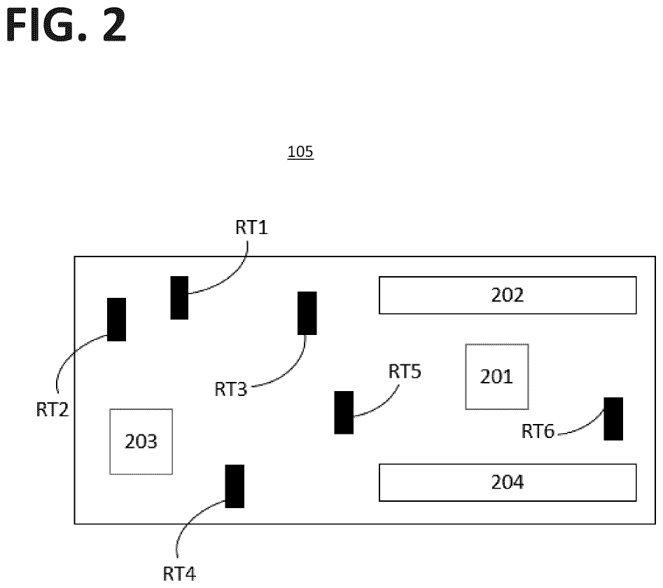

FIG. 2 illustrates the substrate 105, with the location of one or more temperature sensors, labeled (RTx, with x=1, . . . ,6) which may be, for example and by limitation, thermistors. In one implementation, the substrate 105 may be a printed circuit board that includes traces (either at single or at multiple levels) providing connections between electronic components 201, 203, and headers or connection ports 202 and 204.

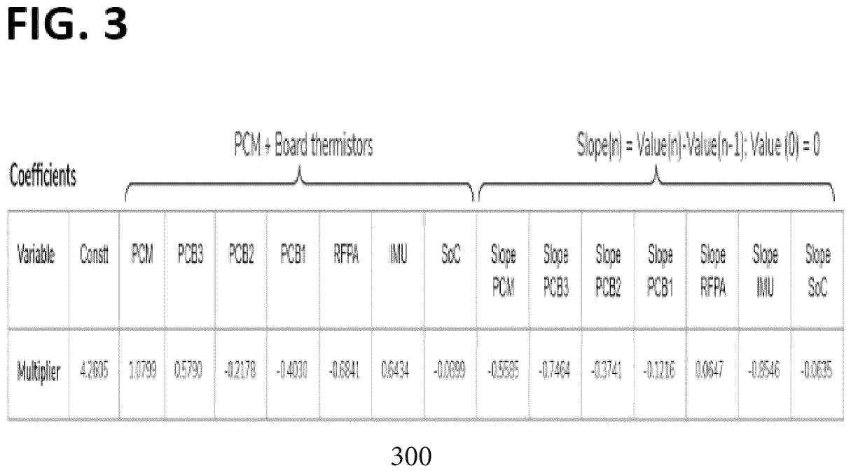

FIG. 3 illustrates an exemplary implementation 300 that relies on the PCM 102 thermistors and the thermistors from the main substrate 105. Generally, an embodiment consistent with the present teachings includes methods and systems wherein temperature measurements are made using a plurality of temperature sensors in the device (e.g., a VR headset), wherein the plurality includes sensors not typically associated with battery temperature measurement and management.

Furthermore, with the embodiments, appropriate actions that would otherwise trigger a remedial action, such as battery current throttling, do not occur as the embodiment provides a more accurate temperature reading than the PCM thermistor alone. In one exemplary embodiment, PCM and multi-layer board (MLB) readings may be converted to degrees centigrade (C) by dividing 10 and 1000 respectively; current output is desirably in (C)×1000. Slopes are desirably in (C).

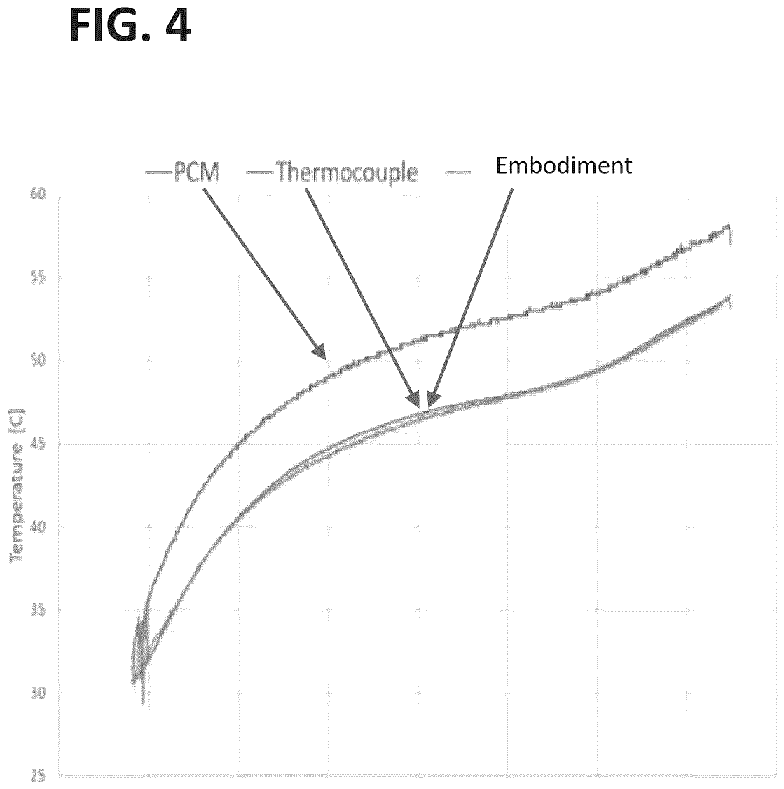

FIG. 4 illustrates exemplary results obtained from the embodiment. As shown, the state-of-the-art battery measurement scheme which relies on the PCM sensors alone deviates by a large margin relative to the actual battery temperature as measured, for experimental purposes, by a thermocouple. In contrast, the embodiment shows agreement with the actual battery temperature, thus providing a more accurate means of estimating the true temperature of the battery pack.

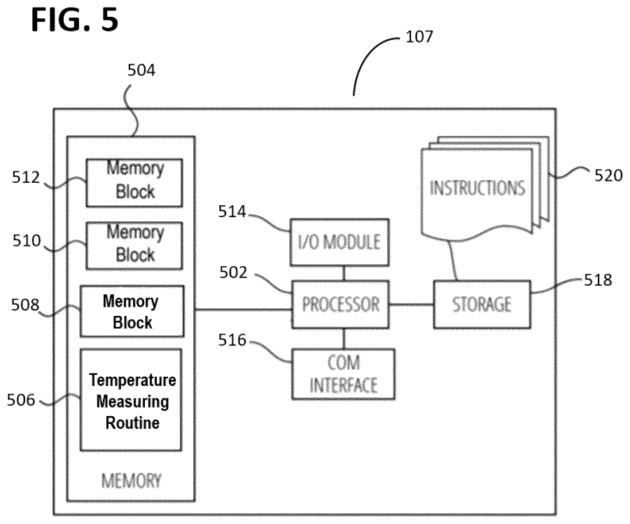

FIG. 5 illustrates a detailed block diagram of the controller 107, including a processor 502 having a specific structure. The specific structure is imparted to the processor 502 by instructions stored in a memory 504 included therein and/or by instructions 520 that can be fetched by the processor 502 from a storage medium 518.

The storage medium 518 may be co-located with the controller 107 as shown or can be located elsewhere and be communicatively coupled to the controller 107. The controller 107 can be a stand-alone programmable system, or it can be a programmable module located in a much larger system. For example, the controller 107 may be integrated into, or embedded within the configuration 100.

The controller 107 may include one or more hardware and/or software components configured to fetch, decode, execute, store, analyze, distribute, evaluate, diagnose, and/or categorize information. Furthermore, the controller 107 can include an (input/output) I/O module 514 configured to interface with a plurality of remote devices, such as a driver controller module. The I/O module 514 can also interface with a switch matrix or a by-pass module. In one embodiment, the I/O module can include one or more data acquisition modules.

The processor 502 may include one or more processing devices or cores (not shown). In some embodiments, the processor 502 may be a plurality of processors, each having either one or more cores. The processor 502 can be configured to execute instructions fetched from the memory 504, i.e. from one of memory block 512, memory block 510, memory block 508, or a temperature measuring routine module 506. The instructions can be fetched from storage medium 518, or from a remote device connected to the controller 107 via a communication interface 516.

Furthermore, without loss of generality, the storage medium 518 and/or the memory 504 may include a volatile or non-volatile, magnetic, semiconductor, tape, optical, removable, non-removable, read-only, random-access, or any type of non-transitory computer-readable computer medium. The storage medium 518 and/or the memory 504 may include programs and/or other information that may be used by the processor 502.

Moreover, the storage medium 518 may be configured to log data processed, recorded, or collected during the operation of the controller 107. For example, the storage medium 518 may store historical patterns, predetermined thresholds, for each of the measurable variables associated with the controller 107. The data may be time-stamped, location-stamped, cataloged, indexed, or organized in a variety of ways consistent with data storage practice.

In one embodiment, the controller 107 may fetch instructions from the temperature measuring routine module 506, which, when executed by the processor 502, cause the processor 502 to perform certain operations.

The operations may include sensing a temperature of at least one of the battery cells 106 of the battery back 104 from a control unit coupled to the controller 107 through a plurality of sensors that terminate the I/O module 514, for example. The operations may further include smoothing out the instantaneous variations of the power and providing a time averaged measurement of temperature to the controller 107 based on sensed battery temperature. The instructions can be sent though the communication interface 516, for example.

The application-specific structure of a processor included in the controller 107 may include instructions configured to perform a fit between the actual temperature of the battery pack and PCM & main thermistors as shown in FIGS. 2 and 3. The controller 107 is configured by the instructions to perform the fit dynamically to predict the battery temperature and to account for the power level changes with different use cases. Further, the controller is further configured by the instructions to perform a method that includes a temperature-based compensation operation as opposed to a measured power-based method.

Furthermore, the exemplary method and hardware of the present disclosure smooth out the instantaneous variations of the power and provides a time averaged measurement of temperature. Another advantage of this embodiment is that different levels of safety margin can be applied during charging and discharging use cases. Moreover, yet another advantage of the embodiments is that they work accurately across different use cases and ambient conditions.

Those skilled in the relevant art(s) will readily appreciate that various adaptations and modifications of the exemplary embodiments described above can be achieved without departing from the scope and spirit of the present disclosure. Therefore, it is to be understood that, within the scope of the appended claims, the teachings of the disclosure may be practiced other than as specifically described herein.

What is claimed is:

1. A method of estimating temperature in a device including a main printed circuit board (PCB), a protection and control module (PCM), and one or more batteries electrically connected to the PCM, the method comprising:
sensing a temperature of the PCB, via a PCB temperature sensor
sensing a temperature of the PCM via a PCM temperature sensor; and
estimating a temperature of at least one of the batteries based on (i) the temperature determined via the PCB temperature sensor and (ii) the temperature determined via the PCM temperature sensor.

2. The method of claim 1, wherein the estimating includes estimating the temperature of two or more of the batteries.

3. The method of claim 1, further comprising predicting a temperature of at least another one of the batteries based on the estimated temperature.

4. The method of claim 3, wherein the predicting is dynamically performed.

5. The method of claim 1, wherein the estimating is representative of power level changes in the at least one battery.

6. The method of claim 1, wherein the one or more batteries form a battery pack, and the estimating includes estimating a temperature of the battery pack.

7. A system comprising:
a main printed circuit board (PCB) including a PCB temperature sensor (i) electrically connected to the PCB and (ii) configured for sensing a temperature thereof;
a protection and control module (PCM) including a processor;
a PCM temperature sensor electrically connected to the PCM and configured for sensing a temperature thereof; and
one or more batteries electrically connected to the PCM;
wherein the processor is configured to estimate a temperature of at least one of the batteries based on (i) the temperature determined via the PCB temperature sensor and (ii) the temperature determined via the PCM temperature sensor.

8. The system of claim 7, wherein the processor is configured to estimate the temperature of two or more of the batteries.

9. The system of claim 7, wherein the processor is further configured to predict a temperature of at least another one of the batteries based on the estimated temperature.

10. The system of claim 9, wherein the predicting is dynamically performed.

11. The system of claim 7, wherein the estimating is representative of power level changes in the at least one battery.

12. The system of claim 7, wherein the one or more batteries form a battery pack, and the estimating includes estimating a temperature of the battery pack.

13. The system of claim 7 wherein at least one of the PCM temperature sensor and the PCB temperature sensor includes one or more thermistors.

14. The system of claim 7, wherein the system is electrically connected to virtual reality (VR) headset.

15. The system of claim 7, wherein the processor is further configured to estimate a temperature of each of the remaining batteries.

16. A tangible computer-readable medium having stored thereon, computer executable instructions that, if executed by a computing device, cause the computing device to perform a method for estimating temperature in a device including a main printed circuit board (PCB), a protection and control module (PCM), and one or more batteries electrically connected to the PCM, the method comprising:
sensing a temperature of the PCB, via a PCB temperature sensor
sensing a temperature of the PCM via a PCM temperature sensor; and
estimating a temperature of at least one of the batteries based on (i) the temperature determined via the PCB temperature sensor and (ii) the temperature determined via the PCM temperature sensor.

17. The tangible computer-readable medium of claim 16, wherein the estimating includes estimating the temperature of two or more of the batteries.

18. The tangible computer-readable medium of claim 17, further comprising predicting a temperature of at least another one of the batteries based on the estimated temperature.

19. The tangible computer-readable medium of claim 18, wherein the predicting is dynamically performed.

20. The tangible computer-readable medium of claim 19, wherein the estimating is representative of power level changes in the at least one of the batteries.
